(19) United States
(12) Patent Application Publication
(10) Pub. No.: US 2026/0205832 A1
(43) Pub. Date: Jul. 16, 2026

(54) SELF-HEALING COMMUNICATION NETWORKS WITH RECONFIGURABLE INTELLIGENT SURFACES

(71) Applicant: Dell Products L.P., Round Rock, TX (US)

(72) Inventors: Tejinder Singh, Manotick (CA); Navjot Kaur Khaira, Manotick (CA); Seán Ahearne, Cork (IE)

(21) Appl. No.: 19/023,156

(22) Filed: Jan. 15, 2025

(51) Int. Cl. G06F 11/07

(52) U.S. Cl. CPC H04W 24/04

(57) ABSTRACT

The technology described herein is directed towards a self-healing communications network based on a trained model set that can autonomously identify and mitigate faults within the network. In one example implementation, described is a system that integrates advanced artificial intelligence (AI) into a reconfigurable intelligent surface (RIS) framework of the communications network for self-healing of the network in the event that any RIS is compromised with respect to its ability to effectively redirect communications. The trained model set can detect faults and damage in the network in real-time, e.g., via an isolation forest model. For such anomalies, the trained model set (e.g., via a support vector machine model) can classify the fault, and autonomously reconfigure (via instructions from a deep reinforcement learning model) the RIS elements to bypass faulty components and restore optimal communication paths. This facilitates resilient communication networks, capable of autonomously maintaining uninterrupted service.

### BACKGROUND

A reconfigurable intelligent surface includes an array of passive reflecting elements, each of which can independently impose a phase shift on the incoming signal. By adjusting the phase shifts of the reflecting elements, the reflected signals can be reconfigured to propagate towards their desired directions. Current communication networks, including those that include reconfigurable intelligent surfaces, are highly susceptible to faults, damage, and anomalies that can disrupt communication service and reduce network reliability.

### BRIEF DESCRIPTION OF THE DRAWINGS

The technology described herein is illustrated by way of example and not limited in the accompanying figures in which like reference numerals indicate similar elements and in which:

FIG. 1 is a representation of an example network environment having multiple reconfigurable intelligent surface (RIS) panels/modules deployed in a mesh configuration with many combinations of RIS-to-RIS links, in accordance with various embodiments and implementations of the subject disclosure.

FIG. 2 is a representation of the example network environment of FIG. 1 in which failure of one of the RIS modules leads to poor network conditions at a user equipment, in accordance with various embodiments and implementations of the subject disclosure.

FIG. 3 is a representation of the example network environment of FIG. 1 in which the network adapts to the module failure based on a trained model set, and reroutes the signals by appropriately reconfiguring the reconfigurable intelligent surfaces in the environment, in accordance with various embodiments and implementations of the subject disclosure.

FIGS. 4 and 5 comprise a sequence diagram of example operations for a self-healing network communications system that includes a RIS, in accordance with various embodiments and implementations of the subject disclosure.

FIG. 6 is a sequence diagram representing an example operations related to an isolation forest model of the trained model set, in accordance with various embodiments and implementations of the subject disclosure.

FIG. 7 is a sequence diagram representing an example operations related to a support vector machine (SVM) model of the trained model set, in accordance with various embodiments and implementations of the subject disclosure.

FIGS. 8 and 9 comprise a sequence diagram representing an example operations related to a deep reinforcement learning (DRL) model of the trained model set, in accordance with various embodiments and implementations of the subject disclosure.

FIG. 10 is a flow diagram showing example operations related to determining, by trained model set based on fault diagnosis data, reconfiguration data for reconfigurable intelligent surfaces, to mitigate a network fault, in accordance with various embodiments and implementations of the subject disclosure.

FIG. 11 is a flow diagram showing example operations related to obtaining reconfiguration data for reconfigurable intelligent surfaces from a trained model set based on network sensor data, in accordance with various embodiments and implementations of the subject disclosure.

FIG. 12 is a flow diagram showing example operations related to obtaining reconfiguration data for reconfigurable intelligent surfaces to bypass a failed communications link, in accordance with various embodiments and implementations of the subject disclosure.

### DETAILED DESCRIPTION

The technology described herein is generally directed towards a self-healing communications network that communicates data (at least in part) via reconfigurable intelligent surfaces; the self-healing network described herein enhances the resilience and reliability of communication networks. As will be understood, the technology described herein uses a trained model set to autonomously identify and mitigate faults within the network, and thereby maintain generally optimal performance and ensure uninterrupted connectivity, including during critical situations such as disaster recovery and emergency response scenarios. This is in contrast to traditional network infrastructure that lacks the capability to dynamically detect and recover from failure issues in real-time, leading to prolonged downtimes and reduced communication efficiency.

In one example implementation, described is a system that integrates advanced artificial intelligence (AI) into the reconfigurable intelligent surface (RIS) framework for self-healing of the network in the event that any RIS is compromised with respect to its ability to effectively redirect communications. By regularly (e.g. generally continuously) analyzing network performance, the trained model set can detect faults and damage in the network in real-time. For such anomalies, the trained model set can autonomously reconfigure the RIS elements to bypass faulty components and restore optimal communication paths. The integration of AI with RIS technology thus enhances network stability while providing a scalable and flexible solution that can adapt to various network conditions and requirements. This facilitates resilient communication networks, capable of maintaining uninterrupted service even in challenging environments.

It should be understood that any of the examples herein are non-limiting. As one example, various artificial intelligent models are described; however these are nonlimiting examples, and other models, including those not yet developed, can be leveraged by the technology described herein. Thus, any of the embodiments, aspects, concepts, structures, functionalities or examples described herein are non-limiting, and the technology may be used in various ways that provide benefits and advantages in communications and reconfigurable intelligent surfaces in general. It also should be noted that terms used herein, such as “optimize” or “optimal” and the like only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. Repetitive description of like elements employed in respective embodiments may be omitted for sake of brevity.

The following detailed description is merely illustrative and is not intended to limit embodiments and/or application or uses of embodiments. Furthermore, there is no intention to be bound by any expressed or implied information presented in the preceding sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Further, it is to be understood that the present disclosure will be described in terms of a given illustrative architecture; however, other architectures, structures, substrate materials and process features, and steps can be varied within the scope of the present disclosure.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

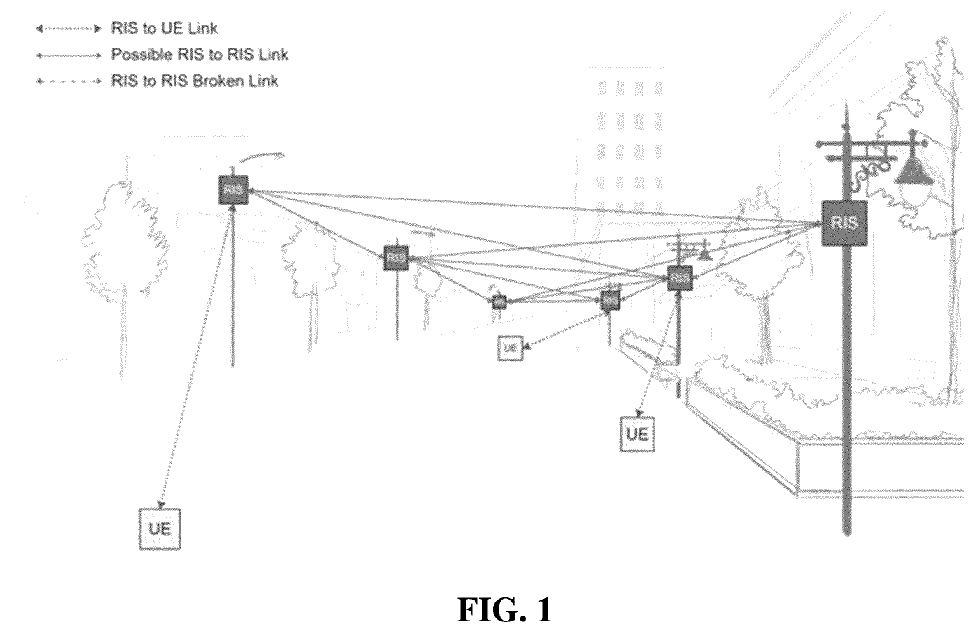

FIG. 1 shows an example environment in which a number of RIS modules are deployed across a network (or part of a network). Possible links between the various RIS modules, and a number of user equipment (UE) devices are shown in FIG. 1, depending on how each RIS module is configured to redirect (e.g., steer) communications signals. The RIS modules are able to communicate with a base station (not explicitly depicted in FIG. 1) and the UEs, as well as to facilitate UE-to-UE communications.

Each RIS module can be equipped with sensors for real-time monitoring of network performance and environmental conditions. These sensors collect the real-time data on signal strength, signal-to-noise ratio (SNR), bit error rate (BER), and other network performance metrics (e.g., signal-to-interference-plus-noise ratio (SINR), latency data and/or throughput data. Environmental sensors detect physical damages or changes that may affect the network such as weather conditions, and/or large physical obstructions.

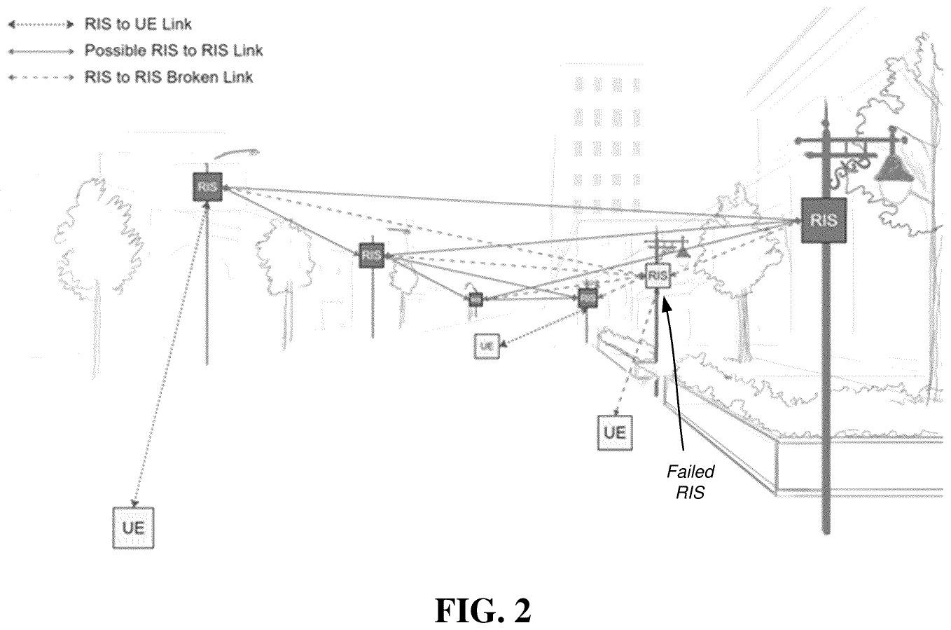

FIG. 2 depicts failure of a RIS module, that is the RIS module is compromised in some way, typically with respect to redirecting signals with adequate signal strength. This could be because of a hardware or software failure, physical damage, weather (e.g., snow covering the RIS surface), an obstruction (e.g., a large vehicle or construction crane is in the link), and so on. This can also be due to detection of an eavesdropper tapping into the link, whereby use of the RIS compromises link privacy/security, making it undesirable for use until the eavesdropping is no longer detected. Note that multiple RIS modules can fail at the same time, which the technology described herein can mitigate; however for purposes of explanation, consider that only one RIS module has failed.

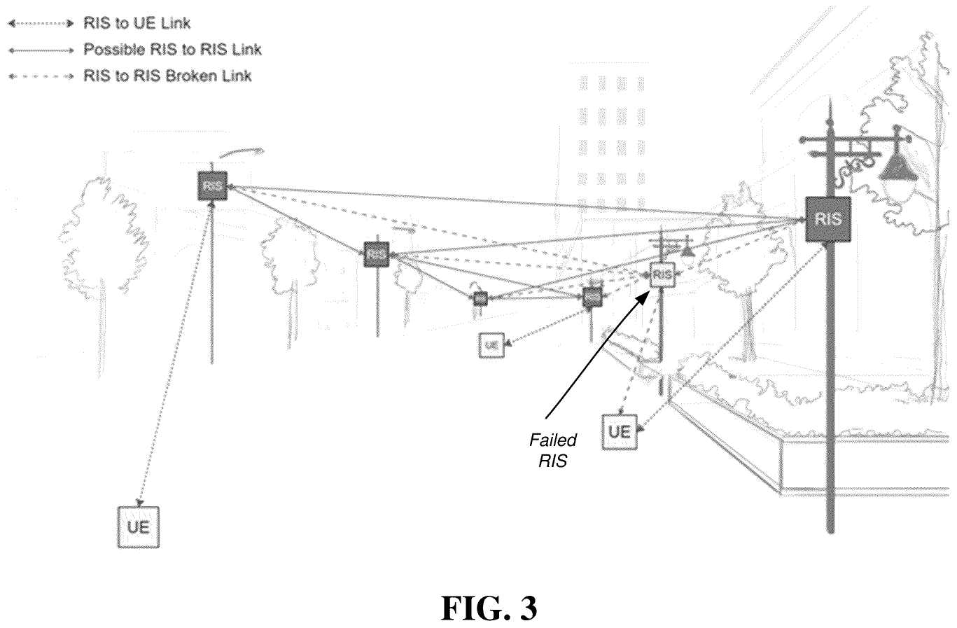

As described herein, the failed (compromised in any way) RIS module is bypassed by rerouting signals to and from the failed RIS module to other RIS modules. A trained AI model set (e.g., there is one such model set at each RIS module) detects the RIS failure, and determines signal rerouting; each RIS can be reconfigured as needed to implement the new routing. An example of such routing to bypass the failed RIS of FIG. 2 is shown in FIG. 3, in which (unlike FIGS. 1 and 2) the rightmost-depicted UE communicates via a different (the rightmost-depicted) RIS module.

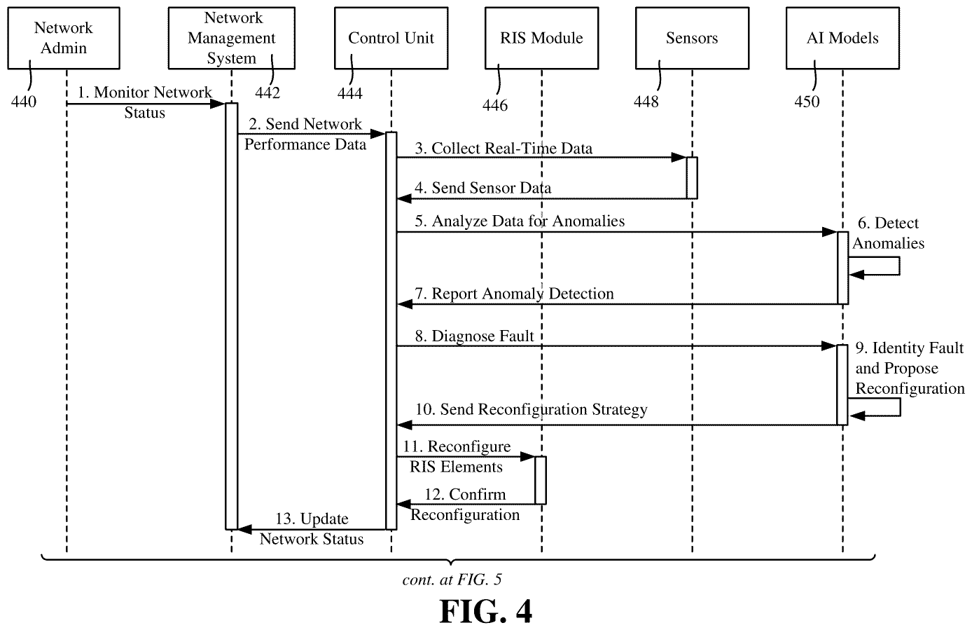

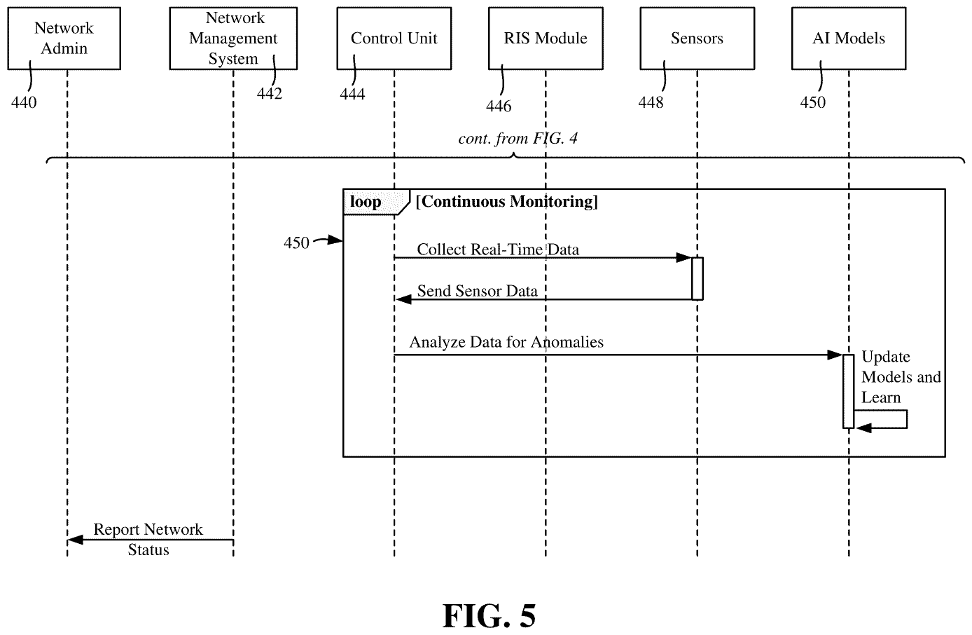

FIGS. 4 and 5 show a sequence diagram of example operations, components and dataflow in a network for one such RIS module. In FIGS. 4 and 5, a network administrator (admin) 440, a network management system 442, and a centralized control unit 444 are shown. The centralized control unit 444 is coupled to the sensors 448 (which may be via the RIS module 446), and incorporates or is closely coupled to one or more controllers/processing units that execute the trained AI models 450 as described herein. One RIS module 446 is shown in FIGS. 4 and 5, although it is understood that this RIS module 446 can represent any of the RIS modules in the network. Among other operations, the RIS module 446 includes a controller or the like that reconfigures the RIS as directed, including for rerouting to bypass a failed RIS.

Each RIS module (e.g., 446) is coupled to the centralized control unit 444 that processes data from the sensors 448, runs the AI models 450, and issues commands to reconfigure the RIS elements as described herein. Upon initialization, the control unit 444 starts collecting baseline data for normal network operation, which can be used for training the AI models 450. The control unit 444 also interfaces with the network management system 442 to provide status updates and receive operational commands. For example, in case of any of the RIS modules failing as shown in FIG. 2, the control unit 444 is updated about this information. Then, based on the AI-decision making, the control unit 444 handles the reconfiguring of the other, neighboring RIS modules to provide appropriate coverage to the UEs in the area, such as shown in FIG. 3, and provides the update to the network management system.

In one implementation, more than one AI model is used in the trained model set. For example, an anomaly detection model (or models) is trained on historical data to recognize patterns that indicate network faults or degradations. In this example implementation, supervised learning is used to train supervised learning model(s) on known fault scenarios and their impact on network performance. Further, deep reinforcement learning (DRL) model(s) are implemented to learn optimal strategies for reconfiguring RIS elements in various fault scenarios, using simulations to explore a wide range of conditions and responses.

Hence, once the models are initially trained, as shown in the sequence of operations (arrows 3-5) in FIG. 3 and in block 550 of FIG. 5, the overall system implementation involves regularly (e.g., virtually continuously) collecting data from the RIS sensors 448 and monitoring network performance metrics. The anomaly detection model analyzes incoming data in real-time to identify potential faults or degradations (arrow 6). If an anomaly is detected (arrow 7), the system triggers (arrows 7 and 8) an AI (e.g., support vector machine, or SVM) model to diagnose the issue and determine the appropriate response (arrows 9 and 10). Based on the diagnosis, another (e.g., the DRL) model selects an optimal reconfiguration strategy for the RIS elements to bypass faulty components and restore optimal communication paths. The control unit 444 sends commands (arrows 11 and 12) to each of the non-failed RIS modules to adjust its phase, amplitude, and direction of the signals.

As also shown in block 550 of FIG. 5, the system monitors the impact of these adjustments and iterates as necessary to fine-tune the configuration. The system also can maintain a feedback loop in which the outcomes of reconfigurations are fed back into the AI models to improve future responses. Such regular relearning helps to ensure that the system adapts to new types of faults and changing network conditions over time. The control unit 444 interfaces with existing network management systems 442 to provide real-time status updates and receive higher-level operational commands. This integration ensures that the self-healing RIS module works well with the broader network infrastructure.

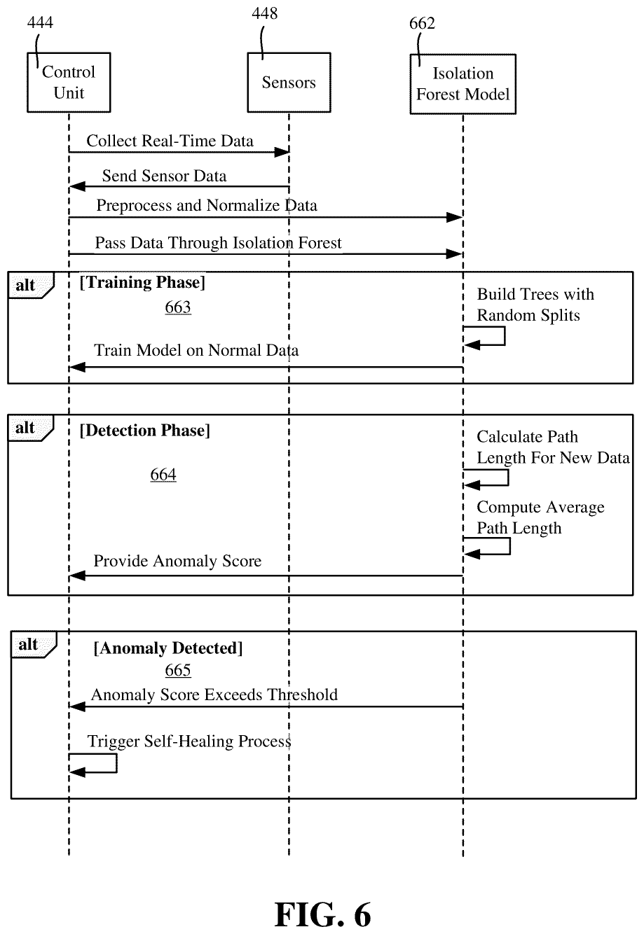

Turning to additional details of the anomaly detection model, the anomaly detection model functions to continuously monitor network performance metrics and detect deviations from normal operation that may indicate faults and damage. One suitable model for this operation is the isolation forest model. The isolation forest model 662, shown in FIG. 6, is particularly useful in scenarios where anomalies are sparse and different from the norm. In the context of self-healing RIS communication networks, the isolation forest model 662 helps detect network anomalies, such as signal degradation, unexpected latency, or environmental disruptions, which can then trigger the self-healing process. A general idea of isolation forests is that anomalies are ‘few and different’, making them easier to isolate. The isolation forest model 662 constructs an ensemble of trees, where each tree is built by randomly selecting feature and then splitting it (block 663) at a random value. This process continues recursively until the data points are isolated.

In the detection phase (block 664), an anomaly score is returned for a data point, which in this connect is based on the sensor data. More particularly, in an isolation forest, the average path length of a data point across the isolation trees in the forest is determined from the number of splits traversed to isolate a data point from the root node to a leaf node. The shorter the average path length, the more likely a data point is considered an anomaly because that data point is easier to isolate in the tree structure through each tree in the isolation forest model to calculate the path length required for isolation. The average path length results in the anomaly score.

In one example scenario, consider that in normal operation, the system continuously collects real-time data from the network sensors (the network performance sensors and the environmental sensors). Consider that a new data point is collected with metrics such as RSSI: −70 dBm, SNR: 20 dB, BER: 0.0001, Latency: 50 ms, Throughput: 100 Mbps, and Temperature: 25 degC. This data point is preprocessed and passed through each tree in the isolation forest model 772 to calculate the path length for isolation. The average path length is computed, resulting in an anomaly score. If (as represented by block 665 of FIG. 6) this score is significantly higher than a predefined threshold, indicating an anomaly, the system triggers the self-healing process. Note that the predefined threshold facilitates proactive anomaly detection, in that a link that is considered a “failure” may still be operational state, yet indicative of an impending issue that sufficient to trigger self-healing before the issue becomes an actual failure.

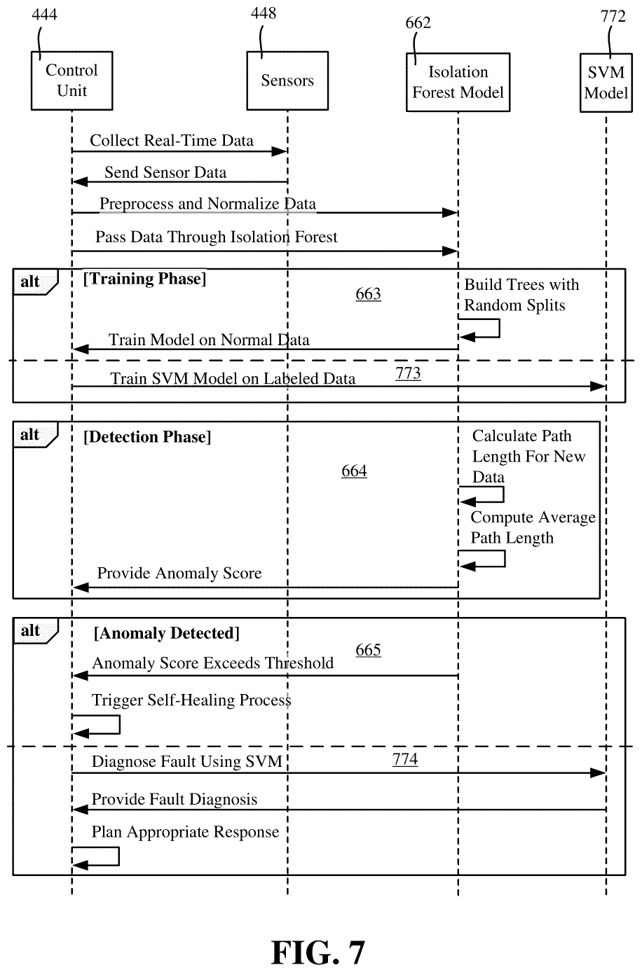

When the isolation forest model 662 detects an anomaly, the control unit 444 collects the relevant features from the real-time data (each data point can be represented as a feature vector). An SVM model 772, described with reference to FIG. 7, classifies the data point into a specific fault category based on learned patterns. The classification result helps in understanding the nature of the fault and its potential impact on the network. The diagnosis aids in planning the appropriate response, such as reconfiguring the RIS elements to bypass the faulty components.

For the fault diagnosis, support vector machines (SVM) can be an effective AI model (FIG. 7) to determine the specific nature and impact of the fault. SVMs are known for their high accuracy and effectiveness in classification tasks, particularly in scenarios with a clear margin of separation between classes. An SVM model can handle binary and multi-class classification problems, making the SVM model 772 versatile for diagnosing various types of faults. Using the features collected from sensors, such as RSSI, SNR, BER, latency, throughput, temperature, humidity, and so on, historical data is labeled with different types of faults or normal operation conditions (block 773 of FIG. 7). The SVM model trains on the labeled dataset (each label indicates the class to which a data point belongs) and learns to classify the data points into fault or normal operation category.

As reiterated in FIG. 7, when the isolation forest model 662 detects an anomaly (block 665), the control unit 444 collects the relevant features from the real-time data. The SVM model classifies (diagnoses, block 774) the data point into a specific fault category based on the learned patterns. The classification result helps in understanding the nature of the fault and its potential impact on the network. The diagnosis aids in planning the appropriate response, such as reconfiguring the RIS elements to bypass the faulty components.

Continuing the example scenario described previously, once the isolation forest model 662 flags an anomaly and triggers the self-healing process, the control unit 444 invokes the SVM model 772 to diagnose the specific fault, classifying it based on the learned patterns from historical data. This diagnosis helps in understanding the cause and impact of the fault, enabling the control unit 444 to plan an appropriate response. The system continues to monitor and adapt, ensuring resilient and reliable communication. The SVM model 772 can be retrained as more and more historical data is collected over time.

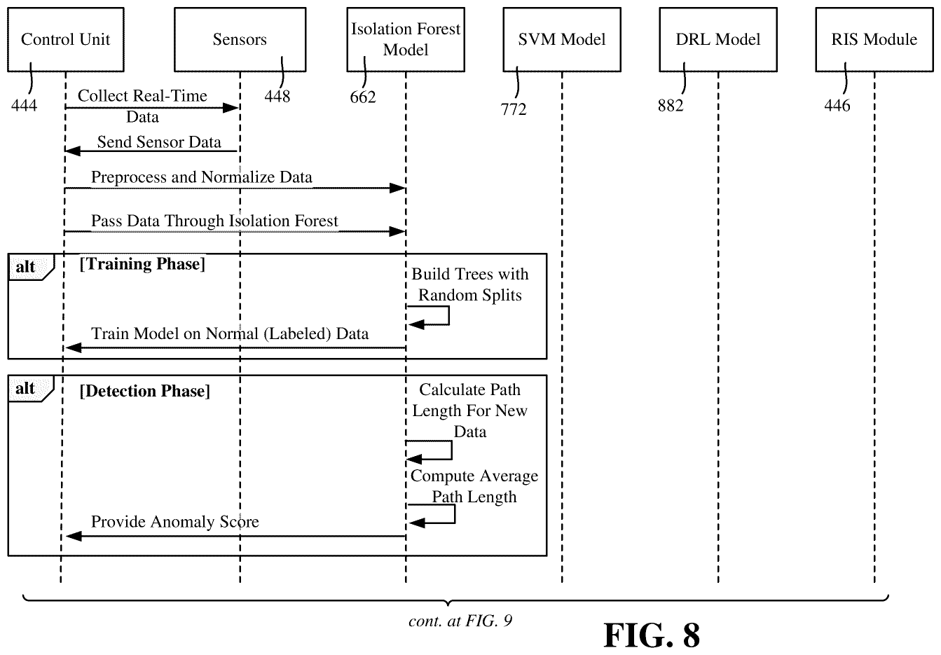

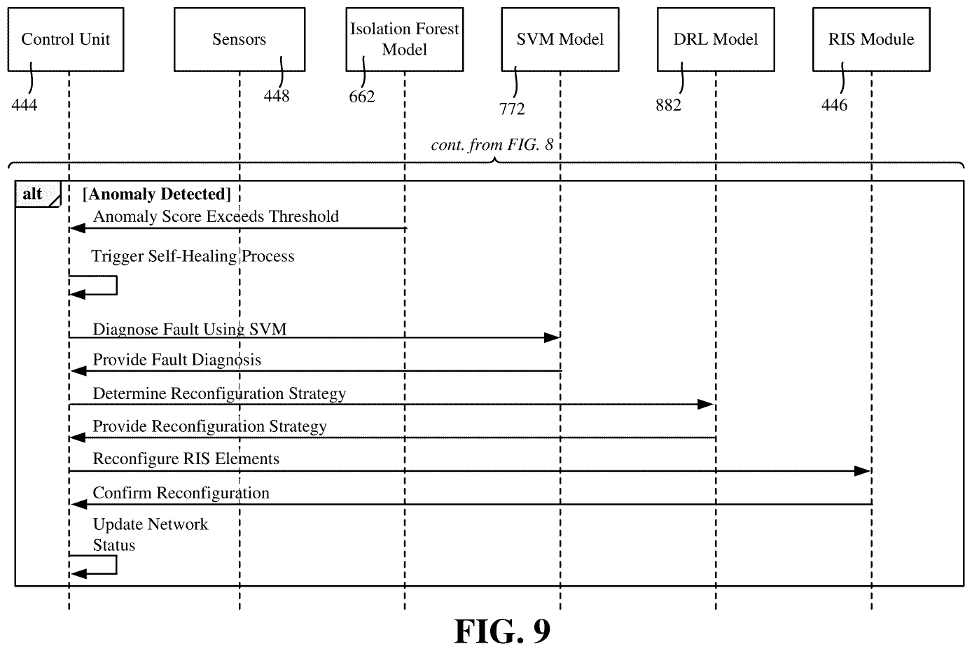

For the RIS reconfiguration step, a deep reinforcement learning (DRL) model 882 (FIGS. 8 and 9) is a suitable RIS reconfiguration model. For example, DRL models like Deep Q-Networks (DQN), Proximal Policy Optimization (PPO), or Advantage Actor-Critic (A2C) can be used. DRL is appropriate for dynamic network environments due to their ability to continuously learn and adapt to new conditions, optimizing the configuration of RIS elements for the improved network performance by considering factors like signal strength, interference, and environmental conditions. DRL models can handle the complexity of managing large-scale RIS deployments, making them suitable for extensive network infrastructures, and can make real-time decisions, allowing a RIS to quickly adapt to changing network conditions and maintain optimal performance.

In RIS reconfiguration, the DRL model 882 represents the current state, including network performance metrics, RIS element status, and environmental conditions, with features such as signal strength, SNR, BER, latency, and throughput. The model selects actions by learning a policy that maps states to actions to maximize network performance, guided by a reward function designed to maximize signal quality, minimize latency, and improve overall network reliability. The model receives feedback on the effectiveness of the chosen actions, adjusting its policy accordingly. During training, the DRL model uses historical data and simulations to learn optimal reconfiguration strategies, and during real-time operation, it continuously updates its policy based on new data and feedback.

Continuing further with the example scenario, once the SVM model has diagnosed the specific fault, the DRL model is then used to determine the optimal reconfiguration strategy for the RIS elements. This is shown with respect to FIGS. 8 and 9, (note that the sequence of operations in FIG. 8 are not described again for purposes of brevity.

As shown in FIG. 9, the control unit 444 invokes the DRL model 882 to obtain a reconfiguration strategy. Based on the returned reconfiguration data, the control unit 444 sends reconfiguration commands to the RIS module 446, which adjusts its settings to bypass the fault and restore optimal network performance. The RIS module 446 confirms the reconfiguration, and the control unit 444 updates the network status, ensuring resilient and reliable communication. Note that more than one RIS module 446 can be reconfigured as part of an overall reconfiguration strategy, e.g., any given RIS module 446 can be reconfigured to bypass the failed RIS.

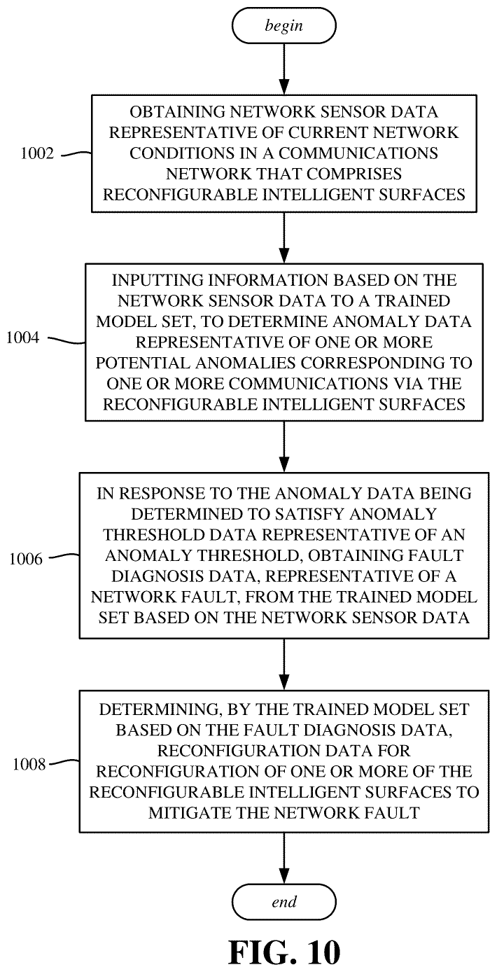

One or more implementations can be embodied in a system, such as represented in the example operations of FIG. 10, and for example can include at least one processor memory that stores computer executable components and/or operations, and at least one processor that executes computer executable components and/or operations stored in the memory. Example operations can include operation 1002, which represents obtaining network sensor data representative of current network conditions in a communications network that comprises reconfigurable intelligent surfaces. Example operation 1004 represents inputting information based on the network sensor data to a trained model set, to determine anomaly data representative of one or more potential anomalies corresponding to one or more communications via the reconfigurable intelligent surfaces. Example operation 1006 represents, in response to the anomaly data being determined to satisfy anomaly threshold data representative of an anomaly threshold, obtaining fault diagnosis data, representative of a network fault, from the trained model set based on the network sensor data. Example operation 1008 represents determining, by the trained model set based on the fault diagnosis data, reconfiguration data for reconfiguration of one or more of the reconfigurable intelligent surfaces to mitigate the network fault.

The reconfiguration data can include respective reconfiguration data portions for respective reconfigurable intelligent surfaces of the reconfigurable intelligent surfaces, and further operations can include communicating one or more of the respective data portions to one or more respective controllers of the respective reconfigurable intelligent surfaces for reconfiguration of the one or more of the respective reconfigurable intelligent surfaces.

The network fault indicates communication failure data based on a compromised reconfigurable intelligent surface of the reconfigurable intelligent surfaces, and the reconfiguration data for the reconfiguration of the one or more of the reconfigurable intelligent surfaces can correspond to rerouting communications to bypass the compromised reconfigurable intelligent surface.

The network sensor data can include network environmental sensor data representative of at least one current environmental condition associated with the communication network.

The network sensor data can include user equipment-related communication information representative of at least one characteristic of at least one communication between at least one user equipment and network equipment of the communication network, and the user equipment-related communication information can have been obtained from one or more network performance sensors. The network performance sensors can sense at least one of: signal strength data representative of at least one signal strength of the at least one communication, signal-to-noise ratio data representative of at least one signal-to-noise ratio of the at least one communication, signal-to-interference-plus-noise ratio data bit error rate data representative of at least one signal-to-interference-plus-noise ratio of the at least one communication, latency data representative of at least one latency of the at least one communication, or throughput data representative of at least one throughput of the at least one communication.

The trained model set can include an isolation forest model, and analyzing the network sensor data to determine the anomaly data can be performed using the isolation forest model.

The network sensor data can include at least one of: signal strength data representative of at least one signal strength of at least one communication via the communication network, signal-to-noise ratio data representative of at least one signal-to-noise ratio of the at least one communication, signal-to-interference-plus-noise ratio data representative of at least one signal-to-interference-plus-noise ratio of the at least one communication, bit error rate data representative of at least one bit error rate of the at least one communication, latency data representative of at least one latency of the at least one communication, throughput data representative of at least one throughput of the at least one communication, humidity data representative of at least one humidity of the at least one communication, or temperature data representative of at least one temperature of the at least one communication; analyzing the network sensor data to determine the anomaly data can include obtaining a data point based on the network sensor data, and the anomaly data can be determined by processing the data point via each tree in an isolation forest of the isolation forest model to determine an anomaly score corresponding to the data point.

The trained model set can include a support vector machine model, and the fault diagnosis data can be obtained from the support vector machine model.

The support vector machine model can be trained on labeled feature data based on historical network sensor data, the network sensor data can include current feature data based on at least one data point representative of at least one of: network sensor data signal strength data representative of at least one network sensor data signal strength of at least one network sensor data signal communicated via the communication network, signal-to-noise ratio data representative of at least one signal strength of at least one communication via the communication network, signal-to-interference-plus-noise ratio data representative of at least one signal-to-interference-plus-noise ratio of the at least one communication, bit error rate data representative of at least one bit error rate of the at least one communication, latency data, throughput data representative of at least one latency of the at least one communication, humidity data representative of at least one humidity of the at least one communication, or temperature data representative of at least one temperature of the at least one communication; obtaining of the fault diagnosis data can include inputting the current feature data into the support vector machine model to obtain the fault diagnosis data.

The trained model set can include a deep reinforcement learning model, and determining the reconfiguration data can be performed by the deep reinforcement learning model.

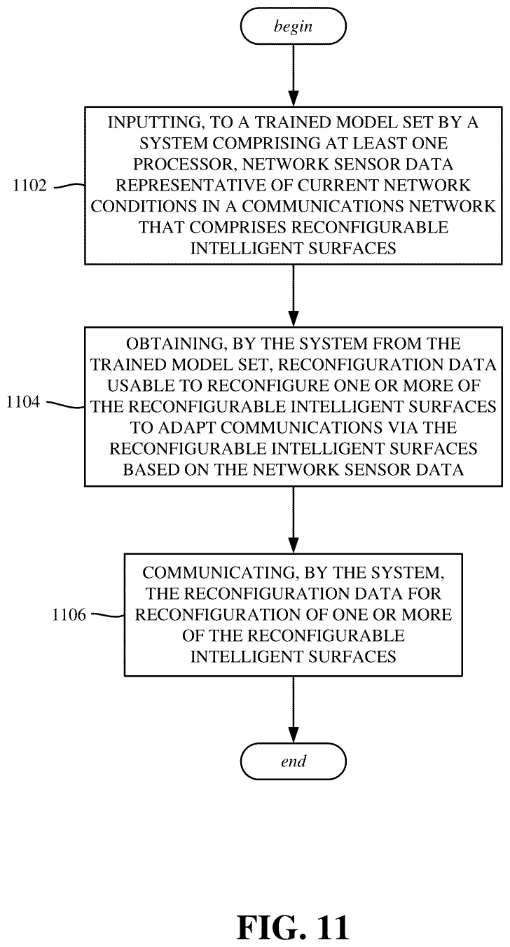

One or more example embodiments and/or implementations, such as corresponding to example operations of a method, can be represented in FIG. 11. Example operation 1102 represents inputting, to a trained model set by a system comprising at least one processor, network sensor data representative of current network conditions in a communications network that can include reconfigurable intelligent surfaces. Example operation 1104 represents obtaining, by the system from the trained model set, reconfiguration data usable to reconfigure one or more of the reconfigurable intelligent surfaces to adapt communications via the reconfigurable intelligent surfaces based on the network sensor data. Example operation 1106 represents communicating, by the system, the reconfiguration data for reconfiguration of one or more of the reconfigurable intelligent surfaces.

The network sensor data can correspond to anomaly data, as determined by an isolation forest model of the trained model set, that satisfies anomaly threshold data, and obtaining the reconfiguration data can be based at least in part on the anomaly data.

The network sensor data can correspond to network fault data as determined by a support vector machine model of the trained model set, and obtaining the reconfiguration data can be based at least in part on the network fault data.

The network fault can indicate that a communications link in the communications network can be a compromised communications link, and communicating the reconfiguration data can include instructing one or more controllers of the one or more reconfigurable intelligent surfaces to bypass the compromised communications link for subsequent communications.

Obtaining the reconfiguration data network sensor data can include inputting the network fault data to a deep reinforcement learning model.

Obtaining the reconfiguration data can include inputting the network sensor data to an isolation forest model of the trained model set, resulting in an anomaly being detected in the communications network, in response to the anomaly being detected, inputting the network sensor data to a support vector machine model of the trained model set to obtain fault diagnosis data, and communicating the fault diagnosis data to a deep reinforcement learning model that generates the reconfiguration data.

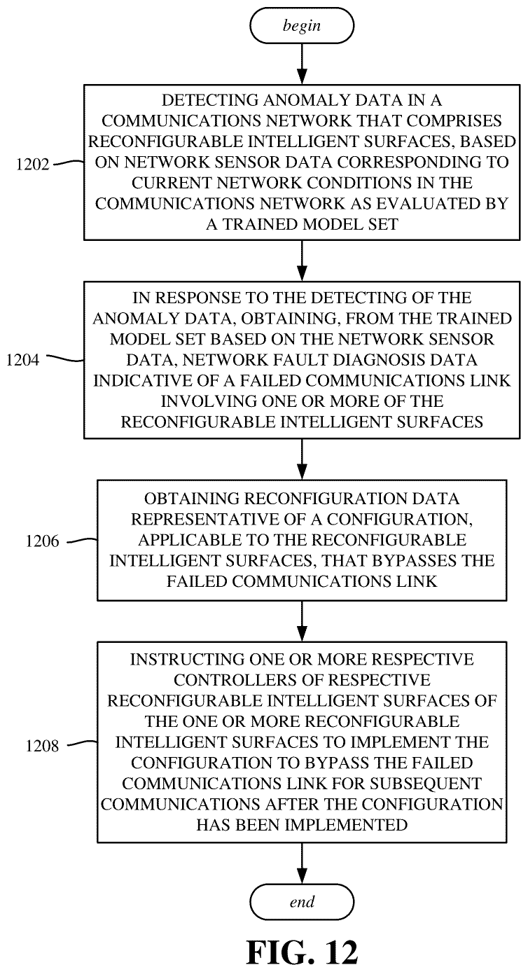

FIG. 12 summarizes various example operations, e.g., corresponding to a machine-readable medium, including executable instructions that, when executed by a processor of a target cluster, facilitate performance of operations. Example operation 1202 represents detecting anomaly data in a communications network that can include reconfigurable intelligent surfaces, based on network sensor data corresponding to current network conditions in the communications network as evaluated by a trained model set. Example operation 1204 represents, in response to the detecting of the anomaly data, obtaining, from the trained model set based on the network sensor data, network fault diagnosis data indicative of a failed communications link involving one or more of the reconfigurable intelligent surfaces. Example operation 1206 represents obtaining reconfiguration data representative of a configuration, applicable to the reconfigurable intelligent surfaces, that bypasses the failed communications link. Example operation 1208 represents instructing one or more respective controllers of respective reconfigurable intelligent surfaces of the one or more reconfigurable intelligent surfaces to implement the configuration to bypass the failed communications link for subsequent communications after the configuration has been implemented.

Detecting the anomaly data can include obtaining an anomaly score, based on the network sensor data, from an isolation forest model of the trained model set, and determining that the anomaly score satisfies an anomaly score threshold value.

Obtaining the network fault diagnosis data can include inputting feature data corresponding to the network state data to a support vector machine of the trained model set, and obtaining the reconfiguration data representative of the configuration can include selecting the configuration, by a deep reinforcement learning model, based at least on part on the network fault diagnosis data.

As can be seen, the technology described herein facilitates real-time adaptive reconfiguration of a network in case of infrastructure failures and/or environmental changes, without manual intervention. this can include the use of DRL for real-time adaptive reconfiguration of RIS elements. Such real-time adaptability ensures that the network can quickly respond to changing conditions, such as new obstacles, equipment failures, maintaining performance without manual intervention.

Further described is comprehensive fault detection to understand root causes of failures, via integrating support vector machines (SVM) for fault diagnosis, which allows precise identification and classification of network faults by leveraging historical data. this capability can provide detailed insights into the cause and impact of issues, enabling the system to understand root causes and facilitate targeted self-healing actions for maintaining high network reliability and performance.

The technology described herein facilitates proactive anomaly detection for early detection of potential issues. Using an isolation forest model for proactive anomaly detection enhances the system's ability to identify potential issues early by recognizing patterns in high-dimensional data. Such early detection allows the system to initiate preemptive self-healing measures, reducing downtime and preventing performance degradation, ensuring continuous network reliability.

In sum, described herein is a technology that offers high network resilience, reduced downtime, scalability, flexibility and is cost-effective. The ability to detect and autonomously recover from faults ensures high network reliability. Rapid identification and mitigation of issues minimize service disruptions and maintain communication continuity. The system can be scaled to cover large and complex network environments, adapting to various conditions and requirements. Automated fault detection and recovery reduce the need for manual intervention, lowering operational costs.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
at least one processor; and
at least one memory that stores executable instructions that, when executed by the at least one processor, facilitate performance of operations, the operations comprising:
obtaining network sensor data representative of current network conditions in a communications network that comprises reconfigurable intelligent surfaces;
inputting information based on the network sensor data to a trained model set, to determine anomaly data representative of one or more potential anomalies corresponding to one or more communications via the reconfigurable intelligent surfaces;
in response to the anomaly data being determined to satisfy anomaly threshold data representative of an anomaly threshold, obtaining fault diagnosis data, representative of a network fault, from the trained model set based on the network sensor data; and
determining, by the trained model set based on the fault diagnosis data, reconfiguration data for reconfiguration of one or more of the reconfigurable intelligent surfaces to mitigate the network fault.

2. The system of claim 1, wherein the reconfiguration data comprises respective reconfiguration data portions for respective reconfigurable intelligent surfaces of the reconfigurable intelligent surfaces, and wherein the operations further comprise communicating one or more of the respective data portions to one or more respective controllers of the respective reconfigurable intelligent surfaces for reconfiguration of the one or more of the respective reconfigurable intelligent surfaces.

3. The system of claim 1, wherein the network fault indicates communication failure data based on a compromised reconfigurable intelligent surface of the reconfigurable intelligent surfaces, and wherein the reconfiguration data for the reconfiguration of the one or more of the reconfigurable intelligent surfaces corresponds to rerouting communications to bypass the compromised reconfigurable intelligent surface.

4. The system of claim 1, wherein the network sensor data comprises network environmental sensor data representative of at least one current environmental condition associated with the communication network.

5. The system of claim 1, wherein the network sensor data comprises user equipment-related communication information representative of at least one characteristic of at least one communication between at least one user equipment and network equipment of the communication network, and wherein the user equipment-related communication information was obtained from one or more network performance sensors.

6. The system of claim 5, wherein the network performance sensors sense at least one of: signal strength data representative of at least one signal strength of the at least one communication, signal-to-noise ratio data representative of at least one signal-to-noise ratio of the at least one communication, signal-to-interference-plus-noise ratio data bit error rate data representative of at least one signal-to-interference-plus-noise ratio of the at least one communication, latency data representative of at least one latency of the at least one communication, or throughput data representative of at least one throughput of the at least one communication.

7. The system of claim 1, wherein the trained model set comprises an isolation forest model, and wherein the analyzing of the network sensor data to determine the anomaly data is performed using the isolation forest model.

8. The system of claim 7, wherein the network sensor data comprises at least one of: signal strength data representative of at least one signal strength of at least one communication via the communication network, signal-to-noise ratio data representative of at least one signal-to-noise ratio of the at least one communication, signal-to-interference-plus-noise ratio data representative of at least one signal-to-interference-plus-noise ratio of the at least one communication, bit error rate data representative of at least one bit error rate of the at least one communication, latency data representative of at least one latency of the at least one communication, throughput data representative of at least one throughput of the at least one communication, humidity data representative of at least one humidity of the at least one communication, or temperature data representative of at least one temperature of the at least one communication, wherein the analyzing of the network sensor data to determine the anomaly data comprises obtaining a data point based on the network sensor data, and wherein the anomaly data is determined by processing the data point via each tree in an isolation forest of the isolation forest model to determine an anomaly score corresponding to the data point.

9. The system of claim 1, wherein the trained model set comprises a support vector machine model, and wherein the fault diagnosis data is obtained from the support vector machine model.

10. The system of claim 9, wherein the support vector machine model is trained on labeled feature data based on historical network sensor data, wherein the network sensor data comprises current feature data based on at least one data point representative of at least one of: network sensor data signal strength data representative of at least one network sensor data signal strength of at least one network sensor data signal communicated via the communication network, signal-to-noise ratio data representative of at least one signal strength of at least one communication via the communication network, signal-to-interference-plus-noise ratio data representative of at least one signal-to-interference-plus-noise ratio of the at least one communication, bit error rate data representative of at least one bit error rate of the at least one communication, latency data, throughput data representative of at least one latency of the at least one communication, humidity data representative of at least one humidity of the at least one communication, or temperature data representative of at least one temperature of the at least one communication, and wherein the obtaining of the fault diagnosis data comprises inputting the current feature data into the support vector machine model to obtain the fault diagnosis data.

11. The system of claim 1, wherein the trained model set comprises a deep reinforcement learning model, and wherein the determining of the reconfiguration data is performed by the deep reinforcement learning model.

12. A method, comprising,
inputting, to a trained model set by a system comprising at least one processor, network sensor data representative of current network conditions in a communications network that comprises reconfigurable intelligent surfaces;
obtaining, by the system from the trained model set, reconfiguration data useable to reconfigure one or more of the reconfigurable intelligent surfaces to adapt communications via the reconfigurable intelligent surfaces based on the network sensor data; and
communicating, by the system, the reconfiguration data for reconfiguration of one or more of the reconfigurable intelligent surfaces.

13. The method of claim 12, wherein the network sensor data corresponds to anomaly data, as determined by an isolation forest model of the trained model set, that satisfies anomaly threshold data, and wherein the obtaining of the reconfiguration data is based at least in part on the anomaly data.

14. The method of claim 12, wherein the network sensor data corresponds to network fault data as determined by a support vector machine model of the trained model set, and wherein the obtaining of the reconfiguration data is based at least in part on the network fault data.

15. The method of claim 14, wherein the network fault indicates that a communications link in the communications network is a compromised communications link, and wherein the communicating of the reconfiguration data comprises instructing one or more controllers of the one or more reconfigurable intelligent surfaces to bypass the compromised communications link for subsequent communications.

16. The method of claim 14, wherein the obtaining of the reconfiguration data network sensor data comprises inputting the network fault data to a deep reinforcement learning model.

17. The method of claim 12, wherein the obtaining of the reconfiguration data comprises:
inputting the network sensor data to an isolation forest model of the trained model set, resulting in an anomaly being detected in the communications network,
in response to the anomaly being detected, inputting the network sensor data to a support vector machine model of the trained model set to obtain fault diagnosis data, and
communicating the fault diagnosis data to a deep reinforcement learning model that generates the reconfiguration data.

18. A non-transitory machine-readable medium, comprising executable instructions that, when executed by at least one processor, facilitate performance of operations, the operations comprising:
detecting anomaly data in a communications network that comprises reconfigurable intelligent surfaces, based on network sensor data corresponding to current network conditions in the communications network as evaluated by a trained model set;
in response to the detecting of the anomaly data, obtaining, from the trained model set based on the network sensor data, network fault diagnosis data indicative of a failed communications link involving one or more of the reconfigurable intelligent surfaces;
obtaining reconfiguration data representative of a configuration, applicable to the reconfigurable intelligent surfaces, that bypasses the failed communications link; and
instructing one or more respective controllers of respective reconfigurable intelligent surfaces of the one or more reconfigurable intelligent surfaces to implement the configuration to bypass the failed communications link for subsequent communications after the configuration has been implemented.

19. The non-transitory machine-readable medium of claim 18, wherein the detecting of the anomaly data comprises obtaining an anomaly score, based on the network sensor data, from an isolation forest model of the trained model set, and determining that the anomaly score satisfies an anomaly score threshold value.

20. The non-transitory machine-readable medium of claim 18, wherein the obtaining of the network fault diagnosis data comprises inputting feature data corresponding to the network state data to a support vector machine of the trained model set, and wherein the obtaining of the reconfiguration data representative of the configuration comprises selecting the configuration, by a deep reinforcement learning model, based at least on part on the network fault diagnosis data.
